(19) United States
(12) Patent Application Publication
(10) Pub. No.: US 2011/0186246 A1
(43) Pub. Date: Aug. 4, 2011

(54) WINDING DEVICE FOR A WINDOW BLIND

(76) Inventor: Shih-Ming LIN, Chiayi Hsien (TW)

(21) Appl. No.: 12/696,173

(22) Filed: Jan. 29, 2010

(51) Int. Cl. E06B 9/56

(52) U.S. Cl. 160/309

(57) ABSTRACT

A winding device includes a seat unit, a rotation unit, and a winding rod unit. The seat unit includes a tube seat that has an open end and that defines an accommodating space, and a front cover that covers the open end of the tube seat. The tube seat has a side wall, a tube wall, and a sleeving axle that extends horizontally from the side wall and that is spaced apart from the tube wall. The rotation unit includes a vertical wheel component having a vertical wheel portion and a vertical axle portion, and a horizontal wheel component having a horizontal wheel portion and a sleeving tube portion. A top portion of the winding rod unit is connected to the vertical axle portion. The winding rod unit may be manipulated to rotate the vertical wheel component, such that the horizontal wheel component is driven to rotate.

### BACKGROUND OF THE INVENTION

1. Field of the Invention

The present invention relates to a winding device, more particularly to a winding device for a window blind.

2. Description of the Related Art

Referring to FIG. 1, a conventional window blind includes a roller 11, a curtain cloth 12 extending downwardly from the roller 11, and a ring chain (or cord) 13 disposed on an end portion of the roller 11 and extending downwardly.

A user can pull the ring chain 13 to rotate the roller 11, such that the curtain cloth 12 can be wound upwardly or extended downwardly.

However, it is possible for the ring chain 13 to wrap around a child's neck if the child sticks his/her head in the loop formed by the ring chain, thereby causing strangling injury. Therefore, there is a need for a winding device for a window blind that solves this problem.

### SUMMARY OF THE INVENTION

Therefore, the object of the present invention is to provide a winding device which winds or unwinds a curtain cloth without the use of a chain or cord.

Accordingly, a winding device of the present invention comprises a seat unit, a rotation unit, and a winding rod unit.

The seat unit includes a tube seat that has an open end and defines an accommodating space, and a front cover that covers the open end of the tube seat. The tube seat has a side wall, a tube wall that extends horizontally from a periphery of the side wall, and a sleeving axle that extends horizontally from the side wall and that is spaced apart from the tube wall.

The rotation unit includes a vertical wheel component and a horizontal wheel component.

The vertical wheel component has a vertical wheel portion rotatable about a vertical axis of the vertical wheel component and that is disposed in the accommodating space, and a vertical axle portion that extends downwardly through the tube seat from a center portion of the vertical wheel portion.

The horizontal wheel component is sleeved on the sleeving axle, and has a horizontal wheel portion driven by the vertical wheel portion so as to rotate about a horizontal axis of the horizontal wheel component, and a sleeving tube portion that extends through the front cover from the horizontal wheel portion and rotates around the horizontal axis with the horizontal wheel portion.

A top portion of the winding rod unit is connected to the vertical axle portion of the vertical wheel component. The winding rod unit may be manipulated to rotate the vertical wheel component, such that the horizontal wheel component is driven to rotate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional winding device;

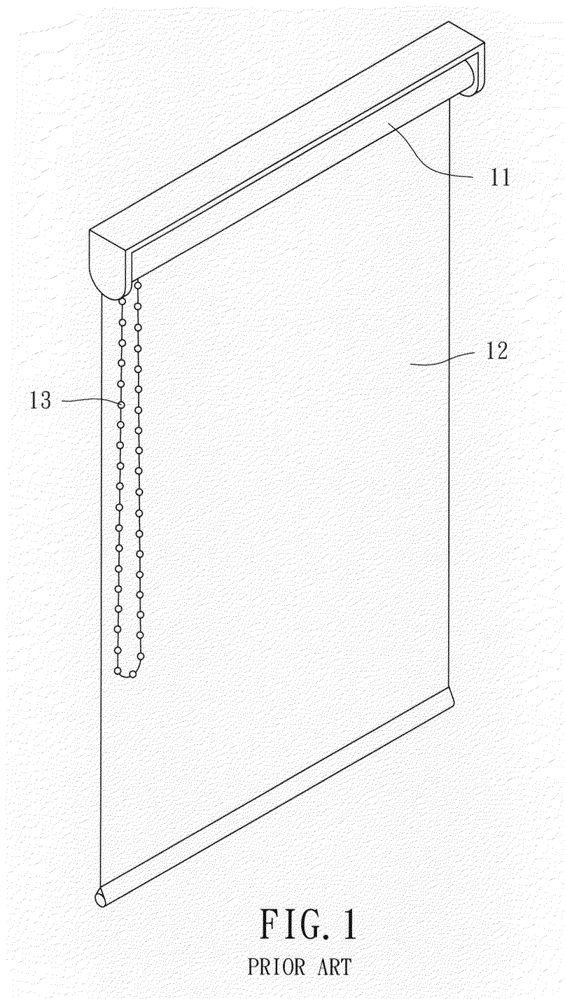

FIG. 2 is a perspective view of a winding device according to a preferred embodiment of the present invention, illustrating the winding device in a state applied to a window blind;

FIG. 3 is a fragmentary exploded perspective view of the winding device of the preferred embodiment;

FIG. 4 is a fragmentary sectional view of the winding device of the preferred embodiment;

FIG. 5 is a fragmentary exploded sectional view of the winding device of the preferred embodiment; and

FIG. 6 is a view similar to FIG. 2, but illustrating how a winding rod unit 5 may be angled to facilitate use thereof.

### DETAILED DESCRIPTION OF THE PREFERRED EMBODIMENT

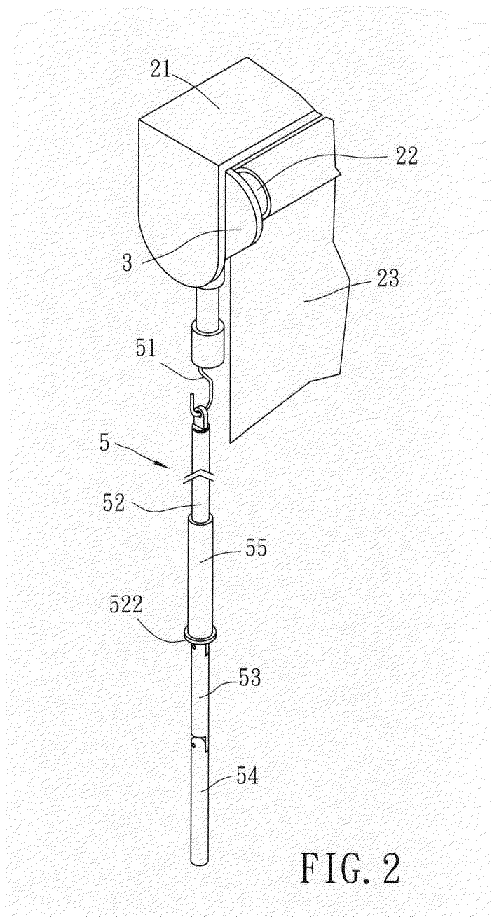

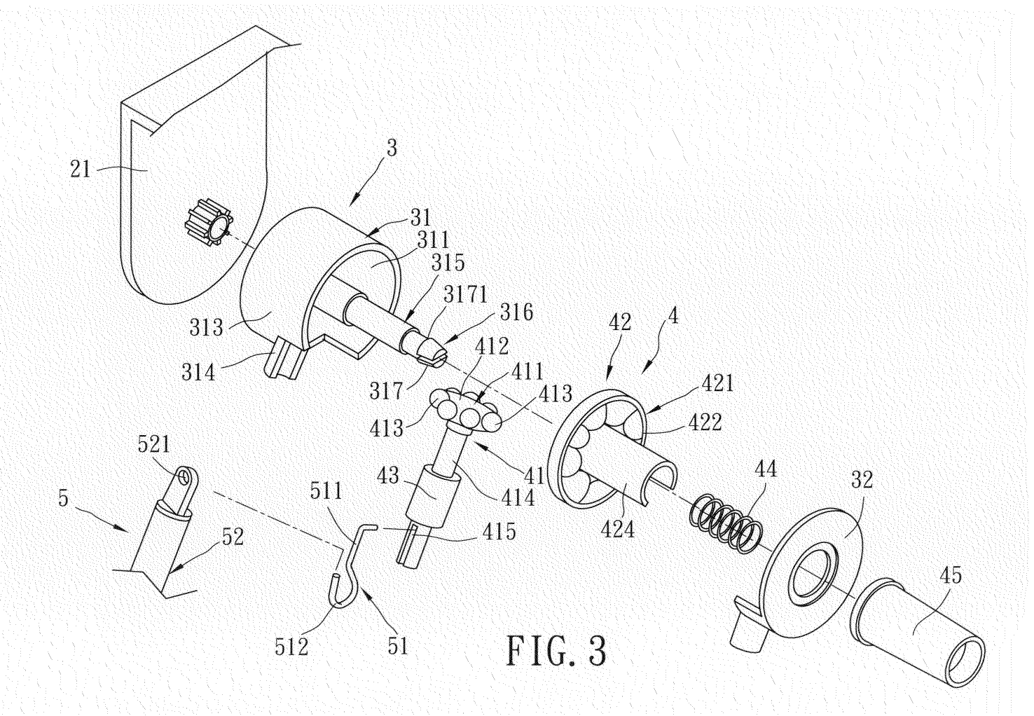

Referring to FIGS. 2 and 3, a preferred embodiment of a winding device for a window blind according to the present invention is mounted to a horizontal frame 21, and is used for driving a winding rod 22 such that a curtain cloth 23 can be wound upwardly or can be extended downwardly. The winding device comprises a seat unit 3 disposed on the horizontal frame 21, a rotation unit 4 disposed on the seat unit 3, and a winding rod unit 5 for rotating the rotation unit 4.

Referring to FIGS. 2, 3, and 4, the seat unit 3 includes a tube seat 31 and a front cover 32. The tube seat 31 is mounted to the horizontal frame 21, has an open end and defines an accommodating space 311. The front cover 32 covers the open end of the tube seat 31. The tube seat 31 has a side wall 312, a tube wall 313 that extends horizontally from a periphery of the side wall 312, an inserting portion 314 that extends downwardly from a bottom portion of the tube wall 313 and that defines a hollow space that is in spatial communication with the accommodating space 311, and a sleeving axle 315 that extends horizontally from the side wall 312 and that is spaced apart from the tube wall 313.

An end portion of the sleeving axle 315 of the seat unit 3 extends through the front cover 32 of the seat unit 3, and has at least two pinching arms 316 that are spaced apart from each other. Each pinching arm 316 is formed with a catch protrusion 317 protruding outwardly from an outer surface of the pinching arm 316 to thereby form a shoulder 3171. These two shoulders 3171 oppose each other.

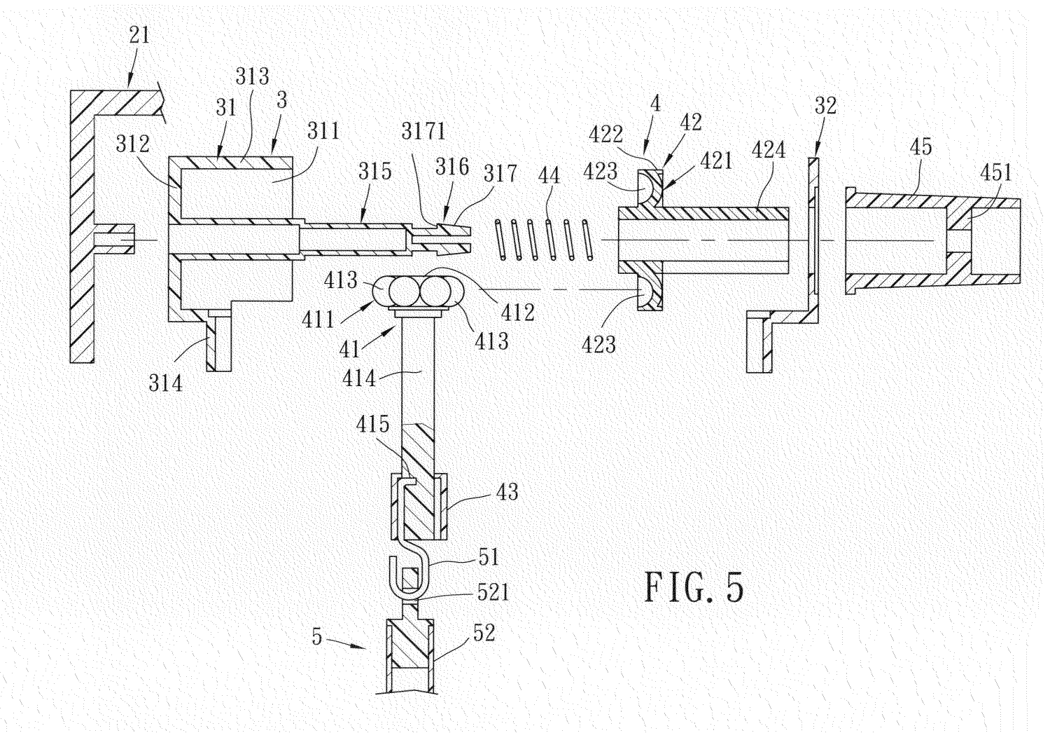

Referring to FIGS. 3, 4, and 5, the rotation unit 4 includes a vertical wheel component 41, a horizontal wheel component 42, a sleeving tube 43, a plurality of sliding rings 44, and a connecting tube 45.

The vertical wheel component 41 has a vertical wheel portion 411 and a vertical axle portion 414. The vertical wheel portion 411 is rotatable about a vertical axis of the vertical wheel component 41, and is disposed in the accommodating space 311. The vertical axle portion 414 extends downwardly through the inserting portion 314 of the tube seat 31 from a center portion of the vertical wheel portion 411.

The vertical wheel portion 411 of the rotation unit 4 includes a wheel portion 412, and a plurality of spherical portions 413 that protrude from a periphery of the wheel portion 412. A bottom end of the vertical axle portion 414 is formed with a long slot 415. The sleeving tube 43 of the rotation unit 4 is movably sleeved on the vertical axle portion 414, and may be sleeved over the long slot 415.

The horizontal wheel component 42 is sleeved on the sleeving axle 315, and has a horizontal wheel portion 421 driven by the vertical wheel portion 411 so as to rotate about a horizontal axis of the horizontal wheel component 42, and a sleeving tube portion 424 that extends through the front cover 32 from the horizontal wheel portion 421 and rotates around the horizontal axis with the horizontal wheel portion 421. The horizontal wheel portion 421 of the rotation unit 4 has a wheel plate 422, and is formed with a plurality of semi-spherical grooves 423 that are arranged along a circumferential direction of the horizontal wheel portion 421.

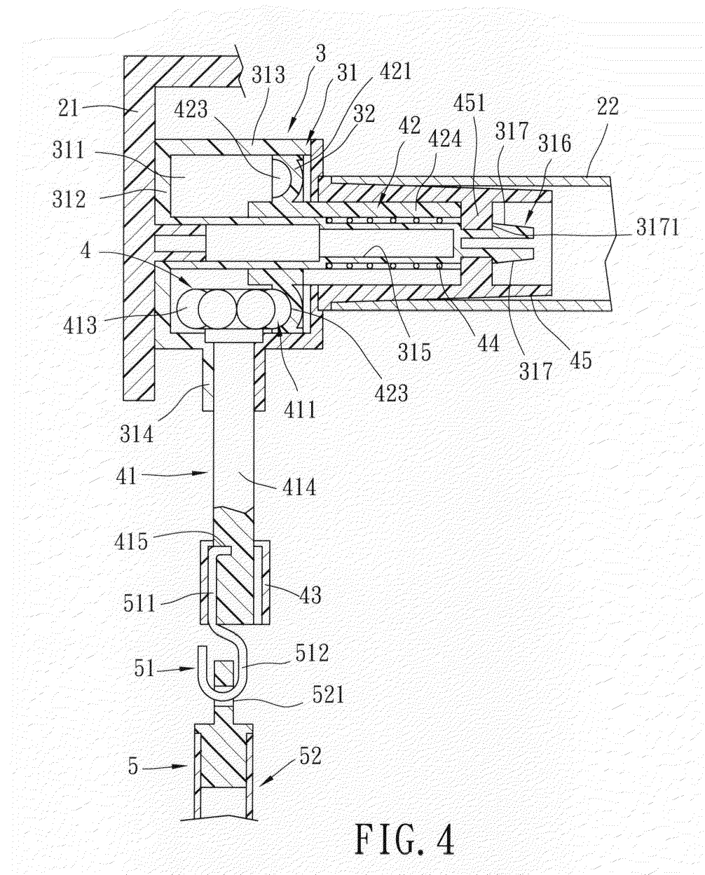

The sleeving tube portion 424 of the horizontal wheel component 42 extends through the front cover 32 (as described above) so as to extend into the connecting tube 45. An inner periphery of the connecting tube 45 is formed with a ring protrusion 451 protruding radially inwardly from an inner surface of the connecting tube 45. When the connecting tube 45 is sleeved on the sleeving tube portion 424, the shoulder 3171 of each of the pinching arms 316 abuts against the ring protrusion 451, such that the connecting tube 45 is secured on the sleeving tube portion 424. In some embodiments, the ring protrusion 451 of the connecting tube 45 is tightly interposed between the shoulders 3171 of the pinching arms 316 and an end of the sleeving tube portion 424. In some embodiments, an outer diameter of the connecting tube 45 decreases in a direction away from the horizontal wheel portion 421 of the horizontal wheel component 42. The connecting tube 45 is connected to the winding rod 22 of the window blind as shown in FIG. 4.

When the rotation unit 4 is mounted to the seat unit 3, the spherical portions 413 of the vertical wheel portion 411 are engaged one at a time with a respective one of the grooves 423 as the vertical wheel component 41 is rotated. As a result, the horizontal wheel portion 421 rotates about the horizontal axis of the horizontal wheel component 42. Hence, axial rotation of the sleeving tube 43 rotates the winding rod 22 to control extension of and taking by of the curtain cloth 23.

The sliding rings 44 are sleeved on the sleeving axle 315 of the seat unit 3, and are interposed between the sleeving axle 315 and the sleeving tube portion 424 of the horizontal wheel component 42. The sliding rings 44 are used for minimizing friction between and wear in the sleeving axle 315 and the sleeving tube portion 424.

Referring to FIGS. 2, 3, 4, and 6, a top portion of the winding rod unit 5 is connected to the vertical axle portion 414 of the vertical wheel component 41. The winding rod unit 5 may be manipulated to rotate the vertical wheel component 41, such that the horizontal wheel component 42 is driven to rotate.

The winding rod unit 5 includes a hook 51, a rotating rod 52, an angling rod 53, a holding rod 54, and a sliding tube 55. The hook 51 is connected to a bottom end of the vertical axle portion 414 of the rotation unit 4. The rotating rod 52 is hooked onto a bottom end of the hook 51, and is able to be manipulated to rotate axially. A top end of the angling rod 53 is pivotally connected to a bottom end of the rotating rod 52. A top end of the holding rod 54 is pivotally connected to a bottom end of the angling rod 53. The sliding tube 55 is sleeved loosely and rotatably on the rotating rod 52.

The hook 51 has an upper hook portion 511 and a lower hook portion 512. The upper hook portion 511 of the hook 51 of the winding rod unit 5 is inserted into the long slot 415 of the vertical axle portion 414. The sleeving tube 43 is sleeved on the bottom end of the vertical axle portion 414 over the long slot 415 such that the upper hook portion 511 of the hook 51 is secured in the long slot 415. The lower hook portion 512 hooks onto a top end of the rotating rod 52.

The top end of the rotating rod 52 is provided with a hole portion 521 for insertion of the lower hook portion 512 of the hook 51. A bottom end of the rotating rod 52 is provided with a ring protrusion 522. A bottom end of the sliding tube 55 is engaged with the ring protrusion 522 such that the sliding tube 55 can be rotatably confined on the rotating rod 52.

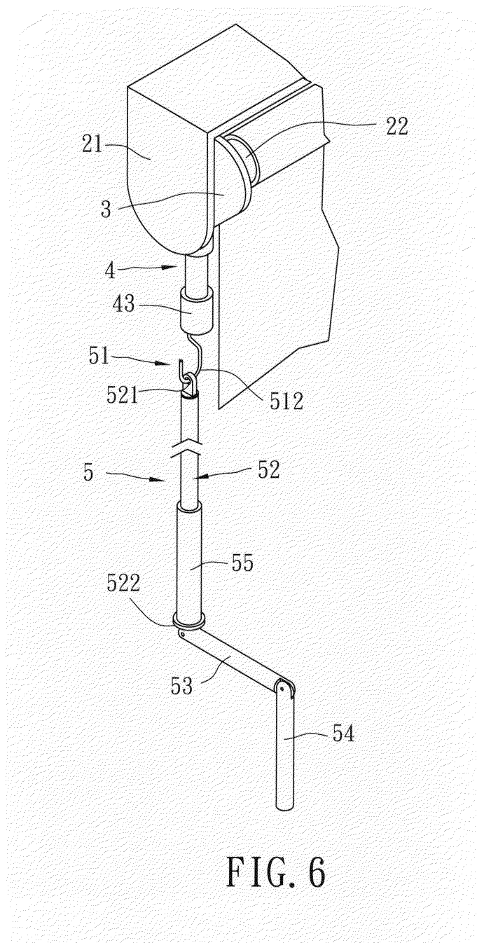

The rotating rod 52, the angling rod 53, and the holding rod 54 may be angled as shown in FIG. 6. In this state, a user can hold the sliding tube 55 sleeved on the rotating rod 52 with one hand, and can hold the holding rod 54 with the other hand. The user may then rotate the holding rod 54 along a circular track. This allows for easy driving and rotating of the rotating rod 52.

Through such rotation of the rotating rod 52, the hook 51 drives and rotates the vertical axle portion 414 of the rotation unit 4, such that the spherical portions 413 of the vertical wheel portion 411 are engaged one at a time with a respective one of the grooves 423, and ultimately, the winding rod 22 is rotated such that the curtain cloth 23 can be wound upwardly or extended downwardly.

It is noted that the winding device of the present invention drives and rotates the winding rod 22 to manipulate the curtain cloth 23 without using any chain or cord. Therefore, the winding device of the present invention can enhance safety.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A winding device for a window blind, comprising:
a seat unit including a tube seat that has an open end and that defines an accommodating space, and a front cover that covers said open end of said tube seat, said tube seat having a side wall, a tube wall that extends horizontally from a periphery of said side wall, and a sleeving axle that extends horizontally from said side wall and that is spaced apart from said tube wall;
a rotation unit including
a vertical wheel component having a vertical wheel portion rotatable about a vertical axis of said vertical wheel component and that is disposed in said accommodating space, and a vertical axle portion that extends downwardly through said tube seat from a center portion of said vertical wheel portion, and
a horizontal wheel component sleeved on said sleeving axle, and having a horizontal wheel portion driven by said vertical wheel portion so as to rotate about a horizontal axis of said horizontal wheel component, and a sleeving tube portion that extends through said front cover from said horizontal wheel portion and rotates around the horizontal axis with said horizontal wheel portion; and
a winding rod unit a top portion of which is connected to said vertical axle portion of said vertical wheel component and which may be manipulated to rotate said vertical wheel component, such that said horizontal wheel component is driven to rotate.

2. The winding device as claimed in claim 1, wherein:
said horizontal wheel portion of said rotation unit is formed with a plurality of semi-spherical grooves that are arranged along a circumferential direction of said horizontal wheel portion; and
said vertical wheel portion of said rotation unit includes a wheel portion, and a plurality of spherical portions that protrude from a periphery of said wheel portion, said spherical portions of said vertical wheel portion being engaged one at a time with a respective one of said grooves as said vertical wheel component is rotated.

3. The winding device as claimed in claim 1, wherein said winding rod unit includes a hook that is connected to a bottom end of said vertical axle portion of said rotation unit, and a rotating rod that is hooked onto a bottom end of said hook and that is able to be manipulated to rotate axially.

4. The winding device as claimed in claim 3, wherein said rotation unit further includes a sleeving tube sleeved on said vertical axle portion, said bottom end of said vertical axle portion being formed with a long slot into which said hook of said winding rod unit is inserted, said sleeving tube being sleeved on said bottom end of said vertical axle portion over said long slot such that said hook is secured in said long slot.

5. The winding device as claimed in claim 3, wherein said winding rod unit further includes an angling rod a top end of which is pivotally connected to a bottom end of said rotating rod, and a holding rod a top end of which is pivotally connected to a bottom end of said angling rod.

6. The winding device as claimed in claim 5, wherein said winding rod unit further includes a sliding tube that is sleeved loosely on said rotating rod.

7. The winding device as claimed in claim 1, wherein said rotation unit further includes a connecting tube that is sleeved on said sleeving tube portion and that is adapted to be connected to a winding rod of the window blind.

8. The winding device as claimed in claim 7, wherein an end portion of said sleeving axle of said seat unit has at least two pinching arms that are spaced apart from each other, each of said pinching arms being formed with a catch protrusion protruding outwardly from an outer surface of said pinching arm to thereby form a shoulder, an inner periphery of said connecting tube being formed with a ring protrusion protruding radially inwardly from an inner surface of said connecting tube, said shoulder of each of said pinching arms abutting against said ring protrusion.

9. The winding device as claimed in claim 8, wherein said ring protrusion of said connecting tube 45 is tightly interposed between said shoulders of said pinching arms and an end of said sleeving tube portion.

10. The winding device as claimed in claim 1, wherein said rotation unit further includes a sliding ring that is sleeved on said sleeving axle of said seat unit and that is interposed between said sleeving axle and said sleeving tube portion of said horizontal wheel component.
